(19) United States
(12) Patent Application Publication
(10) Pub. No.: US 2010/0104816 A1
(43) Pub. Date: Apr. 29, 2010

(54) Optical film

(75) Inventors: Cing-Cin Wu, Tainan City (TW); Tsung-Hsun Wu, Tainan City (TW); Yu-Hung Lin, Tainan City (TW)

Correspondence Address: HAYNES AND BOONE, LLP;IP Section, 2323 Victory Avenue, Suite 700, Dallas, TX, 75219, US

(73) Assignee: EFUN TECHNOLOGY CO., LTD.

(21) Appl. No.: 12/589,772

(22) Filed: Oct. 27, 2009

(30) Foreign Application Priority Data
Oct. 28, 2008 (TW) 097141386

(51) Int. Cl. B32B 3/00; B32B 5/16

(52) U.S. Cl. 428/172; 428/323

(57) ABSTRACT

An optical film includes a substrate unit and a light collecting layer. The substrate unit includes a substrate, and a light diffusing layer that is formed on the substrate, and that has a matrix body with a bottom surface contacting the substrate and a plurality of diffusing particles distributed in the matrix body. The percentage of an area of the diffusing particles projected onto a projection plane based on 100 percent of an area of the bottom surface of the matrix body projected onto the projection plane is greater than 25%. The light collecting layer is formed on the light diffusing layer.

### CROSS-REFERENCE TO RELATED APPLICATION

This application claims priority of Taiwanese application no. 097141386, filed on Oct. 28, 2008.

### BACKGROUND OF THE INVENTION

1. Field of the Invention

This invention relates to an optical film, more particularly to an optical film adapted for diffusing and converging light.

2. Description of the Related Art

Since liquid crystal displays (LCDs) have been widely used, modification and development of optical films for the same are important. In order to reduce thickness, weight, and production costs of LCDs, research in integration of a light diffusing film and a light enhancing film is ongoing.

Conventional optical films capable of diffusing and converging light are classified into two types according to a position of a light diffusing layer thereof. The first type of the optical film has a substrate, a light collecting layer that is disposed on a first surface of the substrate and that confronts an LCD panel, and a light diffusing layer that is disposed on a second surface of the substrate opposite to the light collecting layer, and that confronts a light source. The light diffusing layer of the first type of the optical film is formed by applying a coating on the second surface of the substrate. The coating may be roughened to form the light diffusing layer or may contain diffusing particles that are capable of diffusing light, thereby enabling the light diffusing layer to have haze effect. U.S. Pat. No. 5,600,462, U.S. Pat. No. 6,280,063, U.S. Pat. No. 6,880,946, U.S. Pat. No. 6,356,389, US 2006-0290253, and US 2007-0126074 disclose examples of the first type of the optical film.

The second type of the optical film has a substrate, a light diffusing layer disposed on the substrate, and a light collecting layer disposed oh the light diffusing layer opposite to the substrate, i.e., the light diffusing layer of the second type of the optical film is sandwiched between the substrate and the light collecting layer. The light diffusing layer contains diffusing particles (such as resin particles or metallic oxide particles) so as to diffuse light. Since the light diffusing layer and the light collecting layer are directly connected to each other and have similar refractive indices, a haze effect of the light diffusing layer may be greatly decreased. Consequently, the light diffusing layer is required to contain the diffusing particles that have a refractive index different from those of the light collecting layer and the material of the light diffusing layer for diffusing light more efficiently. US 2007-0115407, US 2007-0128413, KR 10-2005-0114685, and KR 10-2006-0032898 disclose examples of the second type of the optical film.

The light diffusing layers of the optical films belonging to the first and second types are able to eliminate Newton-rings arising from interference between different layers of the optical films, and rainbows resulting from the optical films. Therefore, picture quality produced by LCDs can be increased.

A reverse optical film has a light collecting layer that confronts a light source in an LCD, and induces less Newton-rings and rainbows compared to the first type of the conventional optical film. However, other optical flaws may still exist. For example, friction between the light collecting layer and a light guide plate that is disposed near the light source may lead to wear of the light collecting layer and may hence result in light leakage. White spots and bright spots may be further induced. Therefore, the reverse optical film is required to have a light diffusing layer so as to shield and hide the abovementioned optical flaws.

### SUMMARY OF THE INVENTION

The object of the present invention is to provide an optical film that has a relatively great light-diffusing capability.

According to this invention, an optical film includes a substrate unit and a light collecting layer. The substrate unit includes a substrate, and a light diffusing layer that is formed on the substrate, and that has a matrix body with a bottom surface contacting the substrate and a plurality of diffusing particles distributed in the matrix body. The percentage of an area of the diffusing particles projected onto a projection plane based on 100 percent of an area of the bottom surface of the matrix body projected onto the projection plane is greater than 25%. The light collecting layer is formed on the light diffusing layer.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary sectional view of the first preferred embodiment of an optical film according to this invention;

FIG. 2 is a schematic top view illustrating that a light collecting layer is removed from a light diffusing layer of the optical film according to the first preferred embodiment;

FIG. 3 is a schematic diagram to illustrate a projected area of diffusing particles onto a projection plane according to the first preferred embodiment;

FIG. 4 is a fragmentary sectional view of the second preferred embodiment of the optical film according to this invention; and

FIG. 5 is a fragmentary sectional view of the third preferred embodiment of the optical film according to this invention.

### DETAILED DESCRIPTION OF THE PREFERRED EMBODIMENTS

Before the present invention is described in greater detail, it should be noted that the same reference numerals have been used to denote like elements throughout the specification.

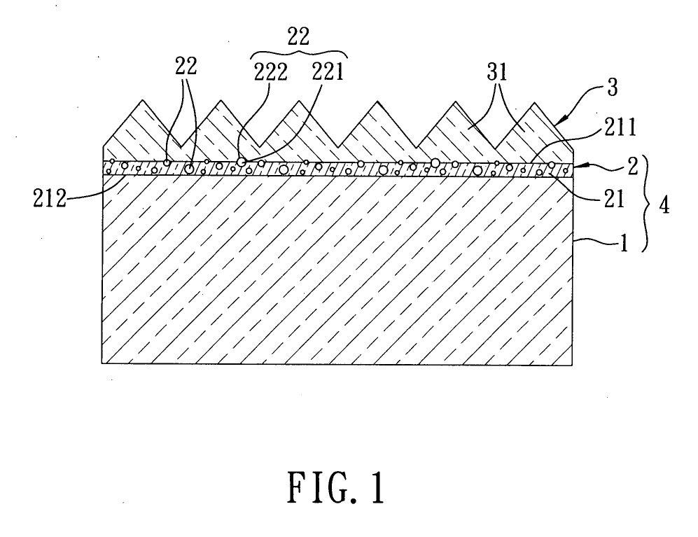

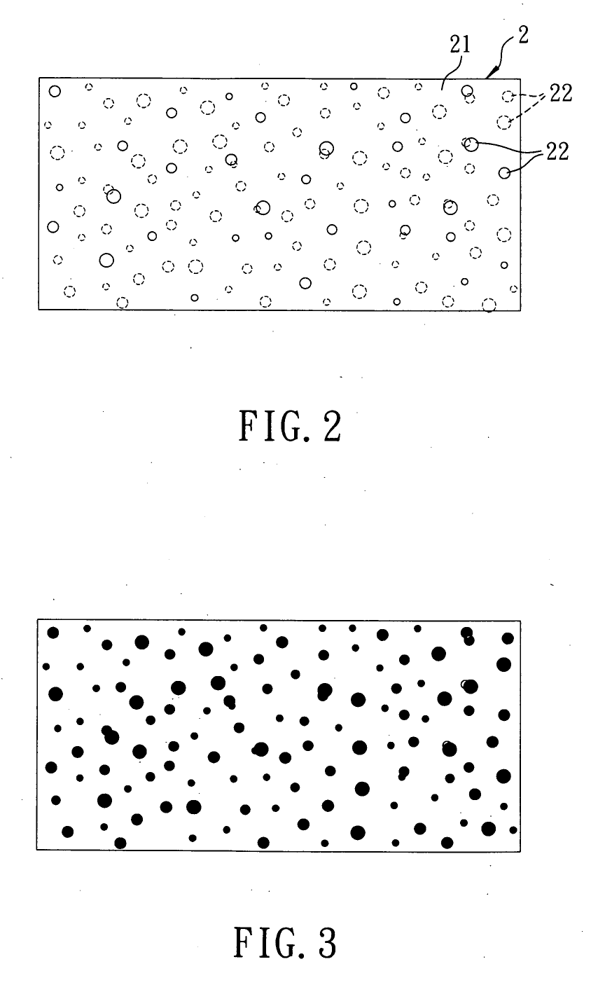

Referring to FIGS. 1, 2, and 3, the first preferred embodiment of an optical film according to the present invention includes a substrate unit 4 and a light collecting layer 3 that is formed on the substrate unit 4. The substrate unit 4 includes a substrate 1, and a light diffusing layer 2 that is formed on a top surface of the substrate 1, and that has a matrix body 21 and a plurality of diffusing particles 22 distributed in the matrix body 21. When the first preferred embodiment of the optical film is applied to an electronic device (not shown) such as an LCD, the substrate 1 is disposed so as to confront a light source (not shown). Therefore, light generated by the light source sequentially passes through the substrate 1, the light diffusing layer 2, and the light collecting layer 3.

The substrate 1 has a thickness that approximately ranges from 50 μm to 250 μm, and is light-transmissive. The substrate 1 may be made from a material selected from the group consisting of polyethylene terephthalate (PET), polycarbonate (PC), polymethyl methacrylate (PMMA), polyethylene (PE), polypropylene (PP), polyvinyl alcohol (PVA), polyvinyl chloride (PVC), and polyurethane (PU). In this embodiment, the substrate 1 is made from PET.

The matrix body 21 of the light diffusing layer 2 has a thickness that approximately ranges from 10 μM to 15 μm, and is made from a light-transmissive resin. In this embodiment, the matrix body 21 is made from acrylic resin. The matrix body 21 has a top surface 211 that is flat and that is connected to the light collecting layer 3, and a bottom surface 212 that contacts the substrate 1. It should be noted that the top surface 211 could be alternately concave and convex in other embodiments.

The diffusing particles 22 of the light diffusing layer 2 may be organic particles made from a material such as PMMA, PC, PE, polystyrene (PS), a copolymer (i.e., MS resin) mainly composed of methyl methacrylate (MMA) and styrene (SM), etc., or may be inorganic particles made from a material such as titanium oxide (TiO₂), silicon oxide (SiO₂), aluminum oxide (Al₂O₃), boron oxide (B₂O₃), calcium oxide (CaO), magnesium oxide (MgO), etc. In this embodiment, the diffusing particles 22 are made from PMMA. Shapes of the diffusing particles 22 may be spherical or irregular. Widths of the diffusing particles 22 approximately range from 3 μm to 16 μm. In this embodiment, the diffusing particles 22 are arranged into different rows in the matrix body 21. It should be noted that the diffusing particles 22 could be arranged into a single row in other embodiments. Some of the diffusing particles 22 respectively have a first portion 221 that is embedded in the matrix body 21 and a second portion 222 that is embedded in the light collecting layer 3.

A total area of dark spots shown in FIG. 3 signifies an area of the diffusing particles 22 projected onto a projection plane, which is designated as A2. It should be noted that some of the diffusing particles 22 indifferent rows might have projected zones overlapping each other on the projection plane. An area of a quadrangle shown in FIG. 3 represents an area of the bottom surface 212 of the matrix body 21 projected onto the projection plane, which is designated as A1. Since a picture produced by a display is two-dimensional (2-D), the 2-D projected areas of the diffusing particles 22 and the bottom surface 212 of the matrix body 21 are considered herein. The percentage of the area of the diffusing particles 22 projected onto the projection plane based on 100 percent of the area of the bottom surface 212 of the matrix body 21 projected onto the projection plane is denoted by X and has the following formula:

X=(A2/A1)×100%

In this embodiment, X is greater than 25%.

The light collecting layer 3 is formed on the top surface 211 of the matrix body 21 and has a plurality of light collecting members 31 that protrude in a direction away from the light diffusing layer 2. In this embodiment, each of the light collecting members 31 is a prism. The light collecting layer 3 may be made from a material such as acrylic ester, urethane acrylate, polyester acrylate, etc. The material used to make the light collecting layer 3 can be the same as the material for forming the matrix body 21, but must be different from the material for making the diffusing particles 22. In this embodiment, the light collecting layer 3 is made from an acrylic material and has a thickness that approximately ranges from 25 μm to 30 μm.

Since the matrix body 21 and the light collecting layer 3 may have similar or equal refractive indices, the diffusing particles 22 are required to have a refractive index different from those of the light collecting layer 3 and the matrix body 21 such that the light diffusing layer 2 is able to diffuse light more efficiently. The refractive indices of the diffusing particles 22 and the light collecting, layer 3 have the following relation:

n2−n1>0.01

where the refractive index of the diffusing particles 22 is n1, and the refractive index of the light collecting layer 3 is n2. In this embodiment, n2−n1=0.05.

### EXAMPLES

Examples 1 and 2, and Comparative examples 1, 2, and 3 were tested for haze and light transmittance. Example 1 belongs to the first preferred embodiment of the optical film and has X equal to 30%. Example 2 belongs to the first preferred embodiment of the optical film and has X equal to 75%. Comparative examples 1, 2, and 3 have structures similar to that of the optical film of this invention, but contain less diffusing particles, thereby respectively having lower values of X. Values of X for Comparative examples 1, 2, and 3 are shown in Table 1.

Haze of substrate units 4 of Examples 1 and 2, and haze of substrate units of Comparative examples 1, 2, and 3 were measured using a haze meter (a product of Nippon Denshoku, model no. NDH-5000) and were tested according to JIS K 7136. Before forming the light collecting layers 3 on the substrate units 4 for Examples 1 and 2, and forming light collecting layers on the substrate units for Comparative examples 1, 2, and 3, measurement of haze was conducted. Regarding the optical film of the present invention, the light diffusing layer 2 can be roughened to increase haze of the substrate unit 4. When the optical film of the present invention and other components of a display are assembled together, bumps and scratches may occur and may hence lead to physical damage. As a result, haze of the substrate unit 4 of the present invention is required to be larger than 40% for reducing effects of the aforementioned physical damage and for increasing degree of uniformity of light transmitted therethrough, thereby efficiently diffusing light. Light transmittance of Examples 1 and 2, and Comparative examples 1, 2, and 3 were measured via the aforementioned haze meter, and were tested according to JIS K 7361. Results are shown in Table 1.

TABLE 1

| | | | Widths of | | |
|---|---|---|---|---|---|
| | | | diffusing | | Light |
| Sample | X | n2 − n1 | particles | Haze | transmittance |
| Example 1 | 30% | 0.05 | 3~16 μm | 50% | 90% |
| Example 2 | 75% | 0.05 | 3~16 μm | 85% | 89% |
| Comparative | 8% | 0.05 | 3~16 μm | 15% | 91.5% |
| example 1 | | | | | |
| Comparative | 18% | 0.05 | 3~16 μm | 25% | 90.4% |
| example 2 | | | | | |
| Comparative | 25% | 0.05 | 3~16 μm | 40% | 90% |
| example 3 | | | | | |

Examples 1 and 2 have better haze effects than those of Comparative examples 1, 2, and 3. Since Comparative example 1 has insufficient diffusing particles (X=8%), the same has almost no light diffusing effect.

Examples 1 and 2, and Comparative examples 1, 2, and 3 were applied to both of NB module and MNT module. NB module is a backlight module for a laptop panel that has a single light tube. MNT module is a backlight module for a desktop monitor panel that has two light tubes. Newton-rings and rainbows were observed directly. Results are shown in Table 2.

TABLE 2

| | | Central | Central | | |
|---|---|---|---|---|---|
| | | luminance | luminance | Newton- | |
| | Sample | (nits) | percentage (%) | ring | Rainbow |
| NB module | Example 1 (30%) | 2817 | 98.5 | Δ | ◯ |
| | Example 2 (75%) | 2700 | 94.4 | ◯ | ⊚ |
| | Comparative | 2861 | 100 | X | X |
| | example 1 (8%) | | | | |
| | Comparative | 2850 | 99.6 | X | X |
| | example 2 (18%) | | | | |
| | Comparative | 2832 | 99 | Δ | Δ |
| | example 3 (25%) | | | | |
| MNT module | Example 1 (30%) | 5334 | 98 | — | ◯ |
| | Example 2 (75%) | 5202 | 95.5 | — | ⊚ |
| | Comparative | 5448 | 100 | — | X |
| | example 1 (8%) | | | | |
| | Comparative | 5425 | 99.6 | — | X |
| | example 2 (18%) | | | | |
| | Comparative | 5381 | 98.8 | — | Δ |
| | example 3 (25%) | | | | |

Notation
X very evident
Δ slightly evident, slightly observed when covered with an LCD panel
◯ slightly observed, not observed when covered with an LCD panel
⊚ not observed
— Newton-rings occurred when double optical films were used. MNT module employing a single optical film produced no Newton-rings.

Since Comparative example 1 (X=8%) and Comparative example (X=18%) have insufficient diffusing particles, Comparative examples 1 and 2 are unable to shield and hide the flaws. Consequently, Newton-rings and rainbows were very evident for Comparative examples 1 and 2. Comparative example 3 (X=25%) is only able to slightly shield and hide the flaws compared to Comparative examples 1 and 2, but is still unsatisfactory. Thus, when the percentage of the area of the diffusing particles 22 projected onto the projection plane based on 100 percent of the area of the bottom surface 212 of the matrix body 21 projected onto the projection plane is greater than 25%, the optical film can shield and hide the flaws to a certain degree. Example 1 (X=30%) is able to induce sufficient luminance and to reduce Newton-rings and rainbows. When NB module and MNT module were respectively covered with LCD panels, rainbows were not observed. Example 2 (X=75%) has even better light diffusing ability. When Example 2 was applied to NB module or MNT module, almost no Newton-rings or rainbows were observed, and sufficient luminance was maintained. Thus, proper arrangement of sufficient amount of the diffusing particles 22 enables the optical film of the present invention to efficiently diffuse light and shield flaws. Furthermore, LCDs employing the optical film of this invention are able to produce pictures that have uniform and high brightness by virtue of the light collecting layer 3 capable of converging light.

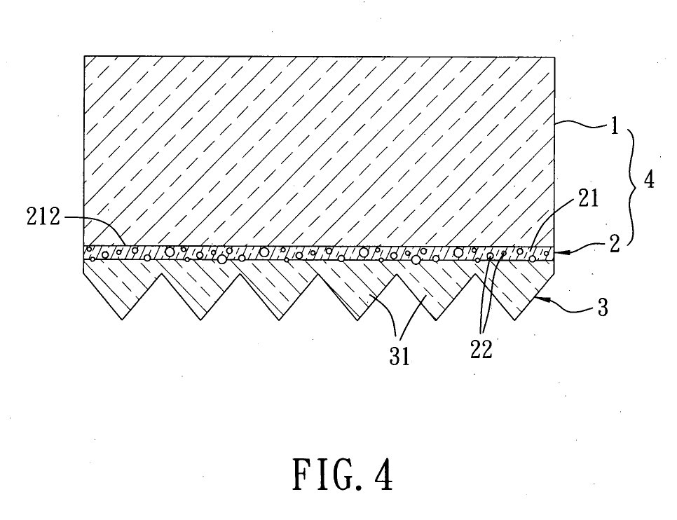

Referring to FIG. 4, the second preferred embodiment of the optical film according to the present invention has a structure similar to that of the first preferred embodiment, but is an upside-down form of the first preferred embodiment. The light collecting layer 3 ds disposed so as to confront a light source (not shown). Therefore, light generated by the light source successively passes through the light collecting layer 3, the light diffusing layer 2, and the substrate 1. The second preferred embodiment of the optical film is hence considered as a reverse optical film. In this embodiment, the percentage of the area of the diffusing particles 22 projected onto the projection plane based on 100 percent of the area of the bottom surface 212 of the matrix body 21 projected onto the projection plane is 30%. The substrate unit 4 has the haze of 50%. The optical film has the light transmittance of 90%.

### Examples

Example 3 belongs to the third preferred embodiment of the optical film. Comparative example 4 is similar to Comparative example 1 but is an upside-down form of Comparative example 1, thereby being regarded as a reverse optical film. Example 3 and Comparative example 4 were applied to NB module. Results are shown in Table 3.

TABLE 3

| | | Central | Central | |
|---|---|---|---|---|
| | | luminance | luminance | |
| | Sample | (nits) | percentage (%) | Flaws |
| NB | Example 3 (30%) | 3150 | 97.8 | ◯ |
| module | Comparative | 3220 | 100 | X |
| | Example 4 (8%) | | | |

Example 3 was capable of inducing sufficient luminance and efficiently diffusing light, thereby having a good flaw-shielding ability. It should be noted that reverse optical films seldom produce Newton-rings and rainbows, and that examples of the flaws in Table 3 are white spots, bright spots, scratches, and so forth.

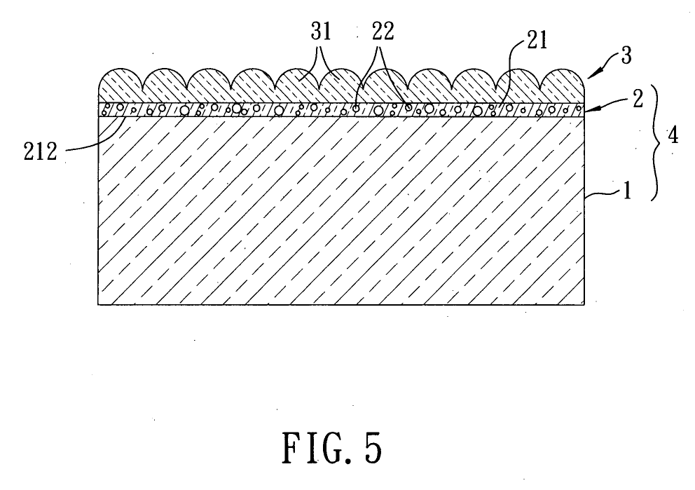

Referring to FIG. 5, the third preferred embodiment of the optical film according to the present invention is similar to the first preferred embodiment except that the diffusing particles 22 are only disposed in the matrix body 21 (i.e., none of the diffusing particles 22 have portions embedded in the light collecting layer 3), and that the light collecting members 31 have curved surfaces. Specifically, the light collecting members 31 have nearly semicircular cross-sections. It is noted that shapes of the light collecting members 31 are not limited as long as the light collecting members 31 are able to converge light. For instance, the light collecting members 31 may be different in radius of curvature, may be pyramidal, may be elongated prisms, or may be curvilinear prisms. In this embodiment, the percentage of the area of the diffusing particles 22 projected onto the projection plane based on 100 percent of the area of the bottom surface 212 of the matrix body 21 projected onto the projection plane is larger than 25%.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An optical film comprising:
a substrate unit including
a substrate, and
a light diffusing layer that is formed on said substrate, and that has a matrix body with a bottom surface contacting said substrate and a plurality of diffusing particles distributed in said matrix body, the percentage of an area of said diffusing particles projected onto a projection plane based on 100 percent of an area of said bottom surface of said matrix body projected onto the projection plane being larger than 25%; and
a light collecting layer formed on said light diffusing layer.

2. The optical film as claimed in claim 1, wherein the percentage of the area of said diffusing particles projected onto the projection plane based on 100 percent of the area of said bottom surface of said matrix body projected onto the projection plane is at least 30%.

3. The optical film as claimed in claim 1, wherein refractive indices of said diffusing particles and said light collecting layer have the following relation:
n2−n1>0.01
where the refractive index of said diffusing particles is n1, and the refractive index of said light collecting layer is n2.

4. The optical film as claimed in claim 1, wherein the optical film has a light transmittance greater than 80%, said substrate unit having a haze greater than 40%.

5. The optical film as claimed in claim 1, wherein said light collecting layer has a plurality of light collecting members that protrude in a direction away from said light diffusing layer.

6. The optical film as claimed in claim 5, wherein each of said light collecting members is a prism.

7. The optical film as claimed in claim 6, wherein each of said light collecting members is elongated.
